(19) United States
(12) Patent Application Publication
(10) Pub. No.: US 2013/0262940 A1
(43) Pub. Date: Oct. 3, 2013

(54) COMPUTER-READABLE NON-TRANSITORY MEDIUM, CONTROL METHOD, AND STORAGE DEVICE

(71) Applicant: FUJITSU LIMITED, Kawasaki-shi (JP)

(72) Inventors: Atsushi TAKAKURA, Kawasaki (JP); Kenji Hattori, Odawara (JP)

(73) Assignee: FUJITSU LIMITED, Kawasaki-shi (JP)

(21) Appl. No.: 13/849,712

(22) Filed: Mar. 25, 2013

(30) Foreign Application Priority Data
Mar. 27, 2012 (JP) 2012-072561

(51) Int. Cl. G06F 11/07

(52) U.S. Cl. CPC G06F 11/0766
USPC 714/57

(57) ABSTRACT

A computer-readable, non-transitory medium storing therein a control program that causes a storage device to execute a procedure, the procedure comprising, acquiring, when a fault occurs in a process of the storage device, attribute information that indicates an attribute of an information processing apparatus that has instructed the process to the storage device, and transmitting error information related the fault and the attribute information.

### CROSS-REFERENCE TO RELATED APPLICATIONS

This application is based upon and claims the benefit of priority of the prior Japanese Patent Application No. 2012-072561, filed on Mar. 27, 2012, the entire contents of which are incorporated herein by reference.

### FIELD

The embodiments discussed herein are related to a computer-readable non-transitory medium, a control method, and a storage device.

### BACKGROUND

In some currently available systems, a host machine, such as a personal computer (PC) or a server apparatus, transmits a read instruction for data to a storage device and causes another storage device to store desired data.

In such systems, an error could occur when the storage device operates in response to an instruction received from the host machine. The storage device suffering from the error generates error information and then transmits the error information to the host machine as a response instead of read data. Upon receiving the error information generated by the storage device, the host machine operates in response to the error information. At this point, the operation performed in response to the error information may be different, depending on the type of host machine. Therefore, the storage device converts the error information into error information in an appropriate form in response to the type of the host machine and then transmits the converted error information to the host machine so that the host machine performs an operation in accordance with the fault that occurred in the storage device.

FIG. 1 illustrates an example of a related art technique. FIG. 1 illustrates a host machine 1 and a storage device 2 that are connected in a mutually communicable fashion. A relay device, such as a switch, may be connected between the host machine 1 and the storage device 2. The storage device 2 includes a memory 3. The memory 3 stores an identifier of the host machine 1 (identification information unique to the host machine 1), and information associated with conversion information that identifies a conversion method of the error information. The conversion information includes information identifying the conversion method as to what type of error information that the error information is to be converted to.

In a state where the memory 3 stores information associating the identifier of the host machine 1 with the conversion information, the storage device 2 receives an instruction A such as a read instruction from the host machine 1. When an error occurs during execution of processing in response to the instruction A, the storage device 2 generates error information (sense data) E in response to the error that occurred. The storage device 2 then identifies the host machine 1 in accordance with information about the transmission source contained in the instruction A, and identifies the conversion information (CONV #1, in this case) corresponding to the identifier (HOST #1) of the host machine 1 by referencing information stored in the memory 3. The storage device 2 further converts the error information E into error information A in accordance with the conversion method (to convert the error information E into the error information A) identified by the conversion information (CONV #1), and then transmits the error information A to the host machine 1. Because upon receipt of the error information A, the host machine 1 may identify an operation to be performed when the error information E is generated, the host machine 1 may execute an operation appropriate for the occurred error in response to the receipt of the error information A.

However, the related art technique takes time and effort because, for each identifier of a host machine, corresponding conversion information is examined, and association relationships are individually stored in advance in the memory of a storage device. If conversion information corresponding to a host machine identifier is unregistered, the storage device is unable to convert the error information into appropriate error information and thus transmits the error information without being converted. Upon receiving the unconverted error information, the host machine could perform an operation unexpected by the storage device (an operation inadequate as an operation in response to an error that has occurred). In some cases, the volume of the host machine (that is, stored data) could become inaccessible, and the operating system (OS) of the host machine 1 could malfunction.

In an aspect, it is desirable to facilitate conversion setting for conversion of error information into appropriate error information.

### SUMMARY

According to an aspect of the invention, a computer-readable, non-transitory medium storing therein a control program that causes a storage device to execute a procedure, the procedure comprising, acquiring, when a fault occurs in a process of the storage device, attribute information that indicates an attribute of an information processing apparatus that has instructed the process to the storage device, and transmitting error information related the fault and the attribute information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a related art technique;

FIG. 2 is a block diagram illustrating a storage device;

FIG. 3 is a function block diagram of a controller;

FIG. 4 is a flowchart illustrating a process of acquiring host machine attribute information;

FIG. 5 illustrates host machine information;

FIG. 6 illustrates host machine response information of an embodiment;

FIG. 7 illustrates host machine response information of the embodiment;

FIG. 8 is a flowchart illustrating a process of acquiring the host machine attribute information;

FIG. 9 illustrates an example of information stored in a master boot record;

FIG. 10 illustrates an example of information that identifies a file system;

FIG. 11 is a flowchart illustrating a procedure for a process that the storage device executes in response to an instruction from a host machine;

FIG. 12 is a flowchart illustrating a procedure for a response process; and

FIG. 13 specifically illustrates the response process.

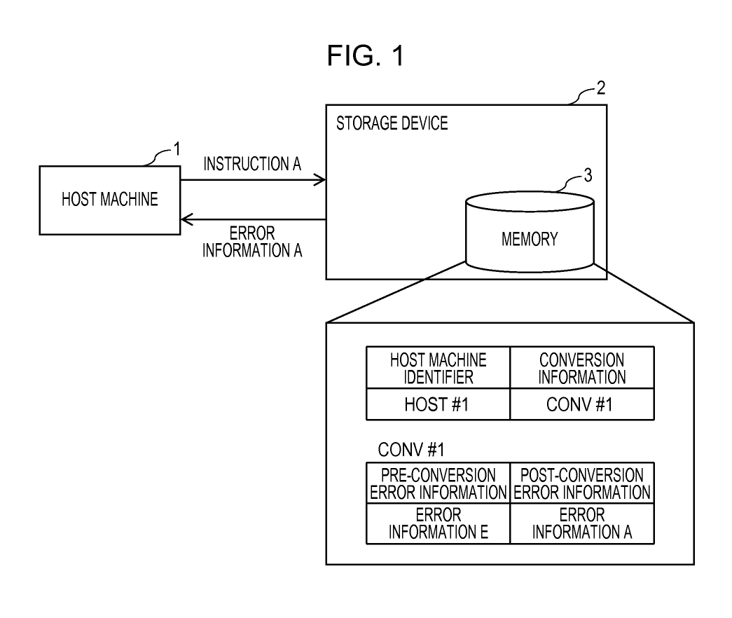

### DESCRIPTION OF EMBODIMENTS

Embodiments are described below with reference to the drawings.

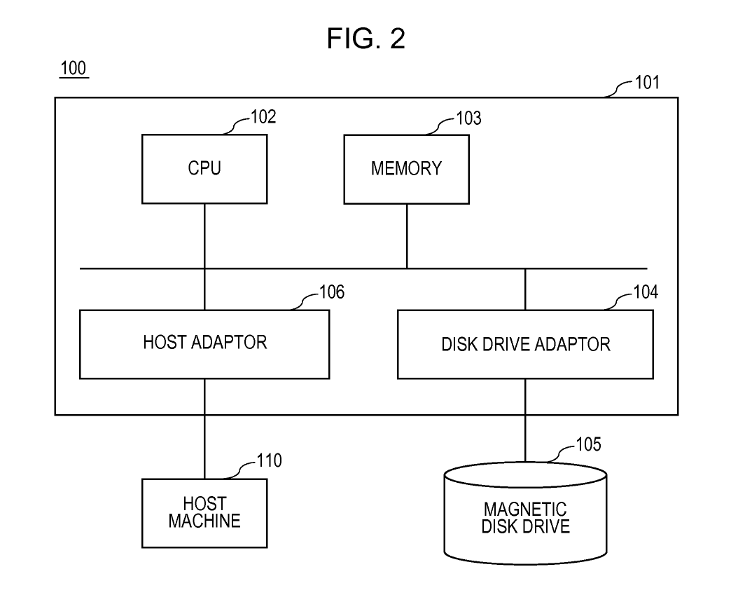

FIG. 2 is a block diagram that illustrates a hardware structure of a storage device 100 of an embodiment. As displayed in FIG. 2, the storage device 100 of the present embodiment includes a magnetic disk drive 105, and a controller 101 that controls the magnetic disk drive 105. The controller 101 includes a central processing unit (CPU) 102, a memory 103, a disk drive adapter 104, and a host adapter 106, which are each connected via a bus in a mutually communicable fashion.

The CPU 102 executes operations, such as calculation processing, to control the controller 101 in the storage device 100. The memory 103 stores information used to control the storage device 100. The memory 103 may also store a program to be executed by the CPU 102.

The controller 101 is connected to the magnetic disk drive 105 via the disk drive adapter 104. For example, small computer system interface (SCSI) may be used to connect the controller 101 to the magnetic disk drive 105.

The magnetic disk drive 105 is, for example, a storage device that stores data in response to an instruction from the host machine 110. In the embodiment, the magnetic disk drive is used. However, a storage device of a different type, including a magnetic tape storage device or a semiconductor storage device, may be employed in place of the magnetic disk drive 105. In addition, for example, a plurality of magnetic disk drives 105 may be connected to the controller 101.

The controller 101 is connected to the host machine 110 via the host adapter 106. For example, Internet SCSI (iSCSI) may be used to connect the controller 101 to the host adapter 106.

The host machine 110 is an information processing apparatus that accesses the storage device 100. The host machine 110 is a personal computer (PC) or a server apparatus, for example. Although FIG. 2 displays an aspect wherein a single host machine 110 is connected to the storage device 100, a plurality of host machines 110 may be connected to the storage device 100.

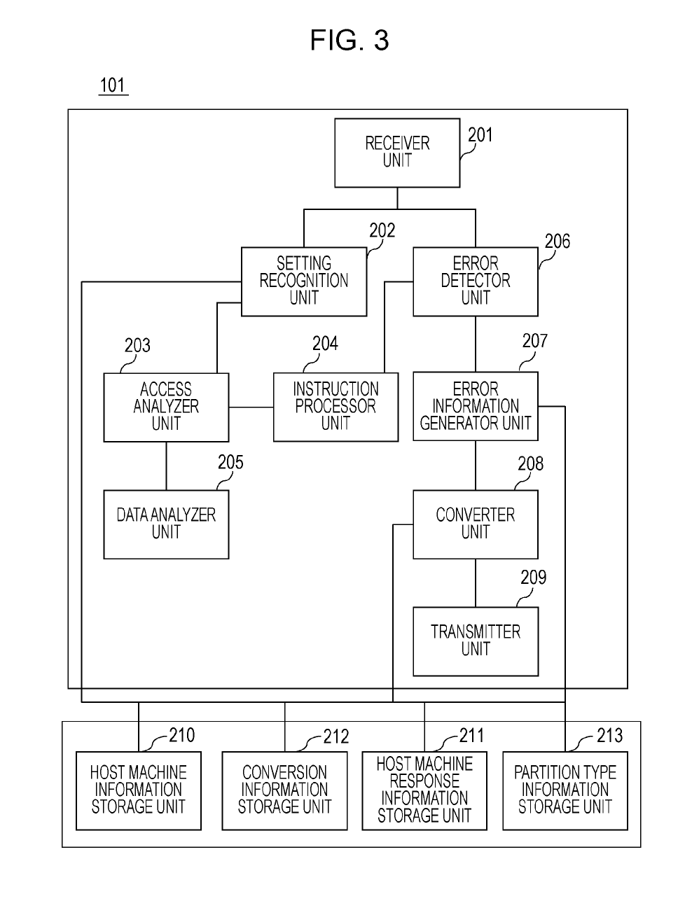

FIG. 3 is a function block diagram illustrating the function of the controller 101. The controller 101 includes a receiving unit 201, a setting recognition unit 202, an access analyzing unit 203, an instruction processing unit 204, a data analyzing unit 205, an error (fault) detecting unit 206, an error information generating unit 207, a converting unit 208, and a transmitting unit 209.

The controller 101 further includes a host machine information storage unit 210, a host machine response information storage unit 211, a conversion information storage unit 212, and a partition type information storage unit 213. The conversion information storage unit 212 converts an error that has occurred into error information that is understandable by the host machine 110. Information stored in each storage unit is described in detail below.

The setting recognition unit 202 through the converting unit 208 may, for example, be implemented when the CPU 102 executes a program stored in the memory 103 of the controller 101. The host machine information storage unit 210 through the partition type information storage unit 213 may, for example, be implemented by using the memory 103 or the magnetic disk drive 105. An interface unit, such as the host adapter 106, communicating with the host machine 110 may be used as the receiving unit 201 and the transmitting unit 209.

Acquisition of host machine attribute information

In the embodiment, if an individual setting to convert error information created by the storage device 100 is not configured in the storage device 100 (that is, if conversion information serving to convert the error information in response to an identifier unique to the host machine 110 is not stored), the controller 101 acquires information (host machine attribute information) identifying the type of operating system (OS) of the host machine 110, which is the source that issued the instruction with which the error occurred. Out of conversion information already stored in the storage device 100, conversion information for the OS of the same type as the acquired OS type is applied to the host machine 110. The created error information is thus converted into error information that the host machine 110 correctly recognizes and processes. Even if the conversion information is not individually configured for the host machine 110, already stored conversions information is used to appropriately convert the error information for the host machine 110, and an appropriate operation may be performed by the host machine 110 for the error.

The procedure of a process to acquire host machine attribute information is described below.

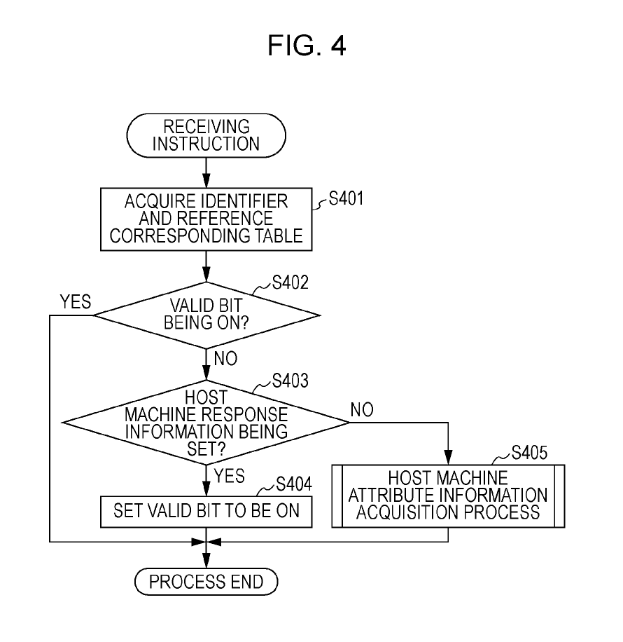

FIG. 4 is a flowchart illustrating the process that the controller 101 performs to acquire host machine attribute information of the host machine 110. Firstly, when the receiving unit 201 in the controller 101 receives an instruction from the host machine 110, the setting recognition unit 202 acquires the host machine identifier contained in the instruction, and then retrieves the host machine attribute information stored in association with the acquired host machine identifier in the host machine information storage unit 210 by referencing the host machine information storage unit 210 (S401).

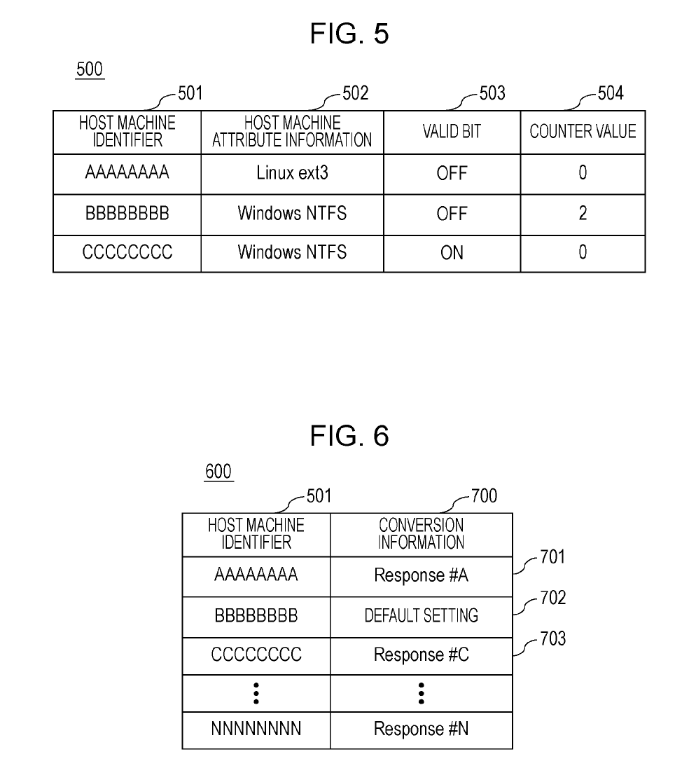

FIG. 5 illustrates an example of host machine information 500. The host machine information 500 contains the host machine identifier 501 that identifies the host machine 110, and a variety of information related to the host machine 110. For example, the variety of information includes host machine attribute information 502, a valid bit 503, and a counter value 504 as illustrated in FIG. 5. The host machine identifier 501 identifies the host machine 110. For example, a World Wide Name (WWN) may be used for the host machine identifier 501. The host machine attribute information 502 is described in detail below. The valid bit 503 is used to determine whether to update the host machine information 500 by means of a host machine attribute acquisition process to be discussed later. The valid bit 503 is flag information, which may be “off” or “on” (or “0” or “1”). In the embodiment, “off” means that the data is not valid, and that an update is necessary, and “on” means that the data is valid, and an update is not necessary.

After referencing the host machine information corresponding to the host machine identifier, the setting recognition unit 202 references the valid bit of the corresponding host machine information and determines whether the valid bit is on (S402). If the valid bit is on, the controller 101 determines that a valid setting has been configured, and ends the host machine attribute information acquisition process.

However, if it is determined in step S402 that the valid bit is off, the setting recognition unit 202 determines whether host machine response information (conversion information) has been configured for the host machine 110 corresponding to the host machine identifier (S403).

The host machine response information will be described. The host machine response information is used to specify a response method configured for the host machine 110 (if a plurality of host machines are used, a plurality of response methods are respectively set therefor).

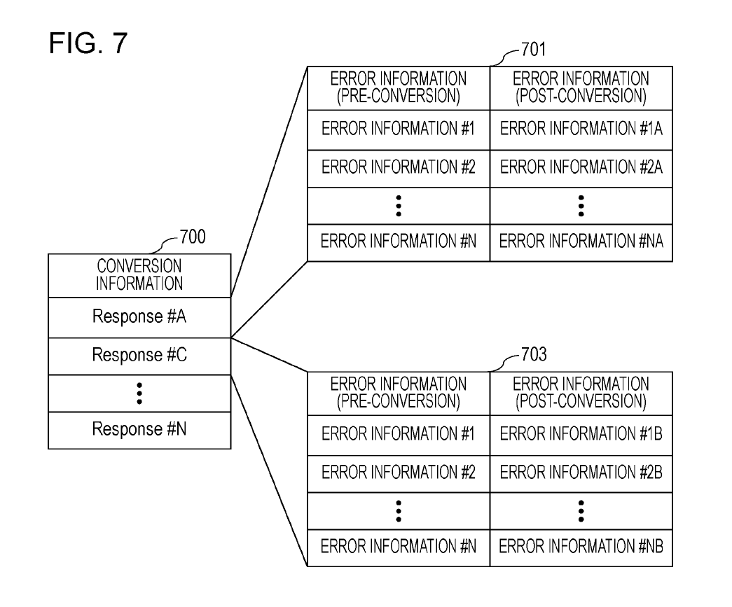

FIG. 6 illustrates an example of host machine response information 600. The host machine response information 600 of FIG. 6 contains a host machine identifier 501 and conversion information 700 associated thereto, and, for example, is stored in the host machine response information storage unit 211. Sense data conversion information is for identifying a conversion method that indicates what error information the error information created by the error information generating unit 207 is to be converted to. FIG. 7 illustrates an example of the conversion information 700 that specifically indicates what kind of conversion the identified conversion method is. For example, response #A 701 as one specific unit of the conversion information 700 contains information related to “convert error information #1 into error information #1A”, and “convert error information #2 into error information #2A”. These pieces of information are set for each piece of the host machine response information (such as response #C and response #N in FIG. 7).

Turning back to FIG. 6, a host machine identifier=AAAAAAAA is associated with conversion information=response #A in the host machine response information 600. In accordance with the information of FIGS. 6 and 7, if an error occurs in the process of the storage device 100 in response to an instruction from the host machine 110 identified by the host machine identifier=AAAAAAAA, and if the error information #1 is generated by the error information generating unit 207, the converting unit 208 converts the error information #1 into the error information #1A.

When a system including the storage device 100 is built up, a system administrator may pre-configure the setting of FIG. 6 that stores the host machine identifier and the conversion information in association with each other and the setting of FIG. 7 that defines the specific conversion method in association with the conversion information. If no setting is configured, any response corresponding to a host machine identifier is not present (as denoted by default setting 702 in FIG. 6).

Turning back to the discussion of step S403 of FIG. 4, the setting recognition unit 202 determines whether the host machine response information of the host machine 110 corresponding to the identifier has been configured. For example, with the situation in FIG. 6, host machine response=response #A is associated with the host machine of host machine identifier=AAAAAAAA. The setting recognition unit 202 thus determines that the host response has been configured to the host machine of the host machine identifier=AAAAAAAA. If it is determined that the host response has been configured, the setting recognition unit 202 updates the valid bit in the table to “on” (S404), and then ends the acquisition process of acquiring the host machine attribute information.

Conversely, there is no response information associated with the host machine that has host machine identifier=BBBBBBBB, and a default setting is thus configured. The setting recognition unit 202 thus determines that no corresponding host machine response has been configured for the host machine identifier=BBBBBBBB. If no host machine response has been set, the controller 101 performs a process of acquiring the host machine attribute information of the host machine 110 (a host machine attribute information acquisition process) (S405).

The host machine attribute information acquisition process in step S405 is described below.

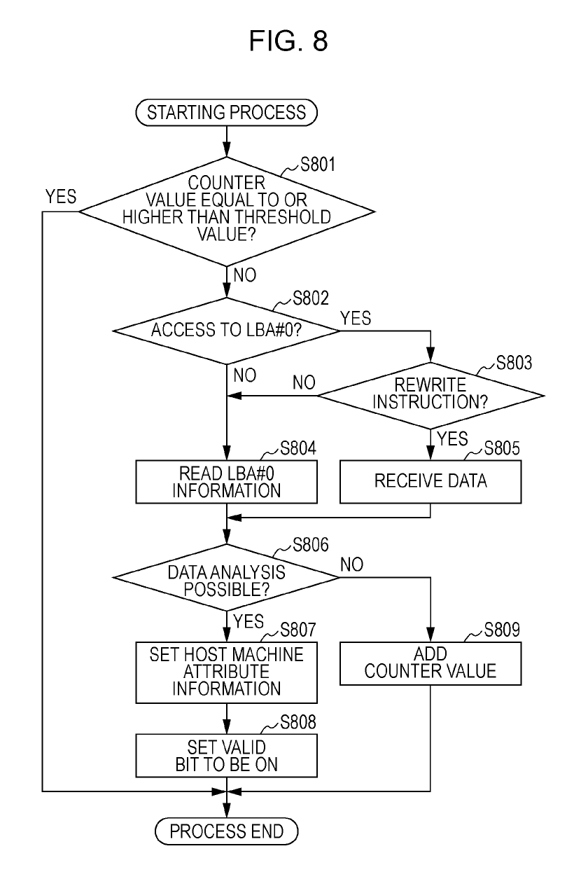

FIG. 8 is a flowchart illustrating a process of the host machine attribute information acquisition process in step S405.

The setting recognition unit 202 first determines whether the counter value 504 of the host machine information referenced in step S401 is greater than or equal to than a specific value (a threshold value) (S801). If the setting recognition unit 202 determines that the counter value 504 is higher than the threshold value, because the possibility that the number of failures of the acquisition process of the host machine attribute is high, and the possibility of failure to obtain the host machine attribute is also high, the controller 101 ends the process to acquire the host machine attribute information. Optionally, the controller 101 may bypass step S801 and proceed to step S802.

Conversely, if the counter value 504 is lower than the threshold value, the access analyzing unit 203 determines whether the instruction received from the host machine 110 is an access to a logical block access (LBA) #0 of a storage area of the magnetic disk drive 105 (S802). The LBA #0 refers to the leading address of the storage area (volume) of the magnetic disk drive 105 that the host machine 110 accesses. When the host machine 110 sets up a partition on the storage device 100, the storage device 100 stores, at this address, OS-specific information such as the master boot record (MBR). The MBR is described in detail below.

If the instruction is not access to LBA #0, the access analyzing unit 203 reads, from a partition table, information corresponding to the host machine 110, which is already stored in LBA #0 (MBR) of the magnetic disk drive 105 (S804). The access analyzing unit 203 then performs the process of step S806. The partition table herein refers to, for example, information that indicates the format of a storage area that the host machine 110 accesses, and that is stored in a given area of the storage device 100. If different partition tables respectively for each of a plurality of host machines 110 are stored in the specific area, the access analyzing unit 203 may, for example, simply read information of the partition table corresponding to a target storage area that is accessed in response to the received instruction.

However, if the instruction received from the host machine 110 is access to LBA #0, the access analyzing unit 203 determines whether the instruction received from the host machine 110 is an instruction to rewrite the information of LBA #0 (S803). If it is determined that the instruction received from the host machine 110 is not an instruction to rewrite the information of LBA #0, the access analyzing unit 203 reads information of a partition table corresponding to a storage area (partition) to which an access is caused in response to the instruction received from the host machine 110 (S804). Then the data analyzing unit 205 executes an operation in step S806. The information of the partition table to be read by the access analyzing unit 203 may be the same as the information of the partition table when the instruction is not access to LBA #0 as described above.

If the instruction received from the host machine 110 is an instruction to rewrite the information of LBA #0, the information stored in LBA #0 corresponding to the host machine 110 is updated. If it is determined that the instruction received from the host machine 110 is an instruction to rewrite the information of LBA #0, the access analyzing unit 203 receives the information for LBA #0 that has been updated in response to the instruction (S805), and the data analyzing unit 205 executes in the processing of step S806 in accordance with data contained in the received rewrite instruction. Optionally, after the data contained in the rewrite instruction is received in step S805, the instruction processing unit 204 may rewrite the information stored in LBA #0 in accordance with the data contained in the received rewrite instruction.

In step S806, the data analyzing unit 205 determines whether the data analyzing unit 205 is able to identify (that is, perform data analysis on) the OS attribute of the host machine 110 in accordance with the information of LBA #0.

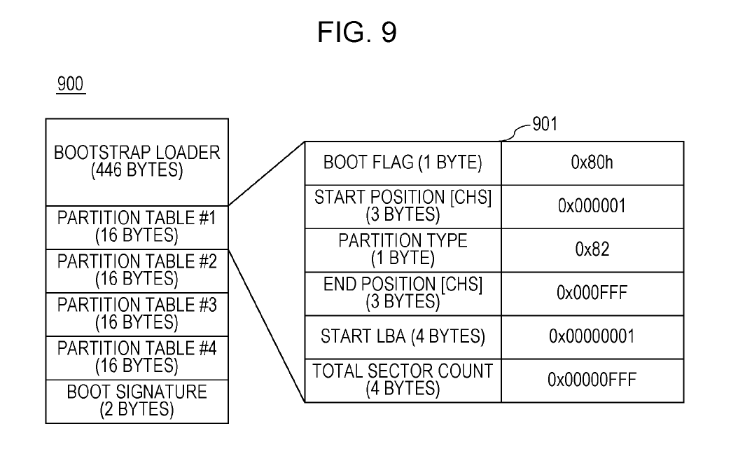

A technique of data analysis according to the embodiment is described. FIG. 9 illustrates an example of information stored in MBR 900. As illustrated in FIG. 9, the MBR 900 contains information, such as a bootstrap loader, partition tables #1 through #4, and boot signature.

The bootstrap loader stores information to control startup of the OS that is stored in a partition. The boot signature is a magic number that indicates the validity of the MBR, and is a hexadecimal number, such as “0xAA55”.

The partition tables #1 through #4 store information for respective partitions, and, for example, each store information such as a boot flag, a partition start position, a partition type identifier, a partition end position, a partition start LBA, and a total sector count of the partition. As an example, FIG. 9 illustrates in detail contents of information 901 stored in the partition table #1. These pieces of information identify, for example, the capacity of each partition, and the file system of the host machine 110 that accesses the partition. The file system herein refers to a function of the OS of the host machine 110 that controls the storage device 100. Therefore, if the file system is identified, the OS of the host machine 110 corresponding to the file system, in other words, a host machine attribute is also identified.

The boot flag indicates whether the partition is bootable. The partition start position is a cylinder head sector (CHS) address at the start position of a partition in the magnetic disk drive. The partition type identifier is information that indicates what OS or what file system is used with the partition. The partition end position is a CHS address at the end position of the partition in the magnetic disk drive. The partition start LBA refers to a LBA at the start position of the partition in the magnetic disk drive. The total sector count refers to the total number of sectors from the start position to the end position of the partition.

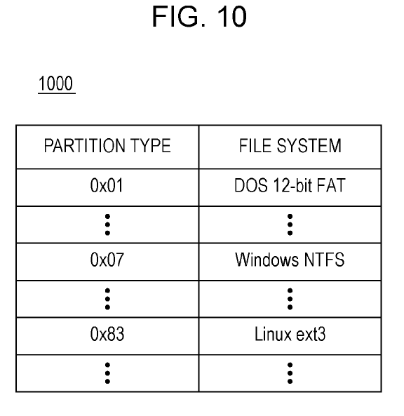

From among these pieces of information, in the embodiment, for example, information of the partition type identifier may be used to acquire the host machine attribute information. The partition type identifier is represented using a two-digit hexadecimal number, and identifies the file system that uses the partition. As illustrated in FIG. 10, the storage device 100 typically stores, for example on the partition type information storage unit 213, information that serves to identify the file system from the partition type identifier (hereinafter referred to as partition type information). As illustrated in FIG. 10, partition type information 1000 indicates that the file system corresponding to a partition type identifier “07” is “Windows (registered trademark) NT File System (NTFS)”, and that the file system corresponding to a partition type identifier “83” is “Linux (registered trademark) ext3”.

The setting recognition unit 202 acquires the information of the partition type identifier from the partition table corresponding to the partition to which access is caused in response to the instruction received from the host machine 110. In this way, the setting recognition unit 202 identifies the file system of the host machine 110 that accesses the partition, from the acquired partition type identifier and the information of FIG. 9. If the file system is identified, the OS of the host machine 110 corresponding to the file system, that is, the host machine attribute is identified, as described above.

Subsequently, in step S806 of FIG. 8, the data analyzing unit 205 determines whether data analysis is possible by determining whether the information for the partition type identifier has been acquired.

If it is determined in step S806 that data analysis is possible, the data analyzing unit 205 acquires file system information corresponding to the identified partition identifier as the host machine attribute information of the host machine 110 (file system information) by referencing the partition type identifier acquired by recognition unit 202, or the partition type information of FIG. 10. In accordance with the acquired information, the data analyzing unit 205 updates the host machine attribute information 502, corresponding to the host machine 110, that is part of the host machine information 500 stored in the host machine information storage unit 210 (S807). Upon updating the host machine attribute information 502, the data analyzing unit 205 updates the valid bit 503 corresponding to the host machine 110 of the host machine information 500 to “on” (S808), and then ends the host machine attribute information acquisition process. However, if it is determined that data analysis is difficult, the data analyzing unit 205 adds 1 to the counter value 504 corresponding to the host machine 110 on the host machine information 500. In this case, the counter value 504 becomes information indicating a failure count for the acquisition of the host machine attribute information of the host machine 110. For example, if the counter value 504 is greater than a specific value (for example, a threshold value as a natural number greater than or equal to 1) in the operation in step S801, the setting recognition unit 202 determines that the host machine attribute information of the host machine 110 is difficult to acquire, and that the host machine attribute information acquisition process may be skipped. Optionally, the valid bit may be set to “on” in step S808, and the counter value 504 may be reset to an initial value (such as “0”).

Through the above process, the host machine attribute information of the host machine 110 may be acquired for the host machine 110 having no host machine response information configured therein, and may be stored in the host machine information storage unit 210.

Process when Fault Occurs

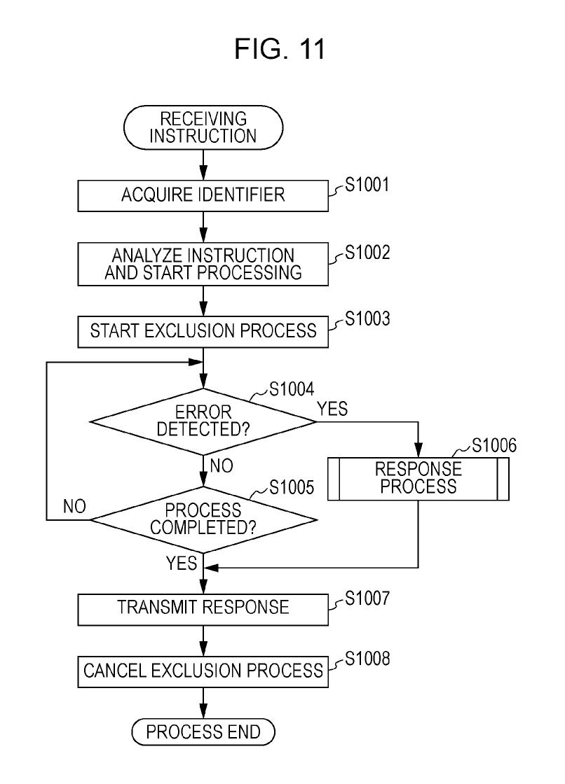

The situation wherein a fault may occur in the system according to the embodiment while the storage device 100 executes a process in response to an instruction received from the host machine 110 will be described. FIG. 11 is a flowchart illustrating a process that the storage device 100 executes if a fault occurs while the storage device 100 is operating.

When the receiving unit 201 receives an instruction from the host machine 110, the setting recognition unit 202 acquires the host machine identifier contained in the received instruction (S1001).

With the host machine identifier acquired, the access analyzing unit 203 analyzes the received instruction, and the instruction processing unit 204 starts a process based on the instruction (S1002).

As illustrated in FIG. 11, the instruction processing unit 204, when starting the process, may execute an exclusion process on the volume or the address to be accessed (S1003). As a result, data destruction that could occur with concurrent access to the data during the execution of the process may be avoided.

While the instruction processing unit 204 executes processing based on the instruction, the error detecting unit 206 monitors whether a fault occurs in the processing (S1004 and S1005). If the processing completes without any fault, the transmitting unit 209 transmits a response to the host machine 110 (S1007).

Conversely, if the error detecting unit 206 detects a fault in the process performed by the instruction processing unit 204, a sense data response process in step S1006 is performed.

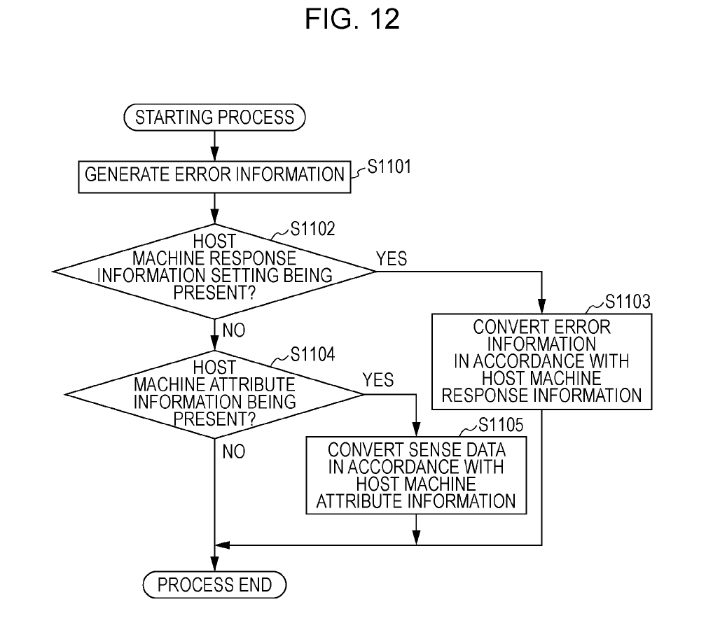

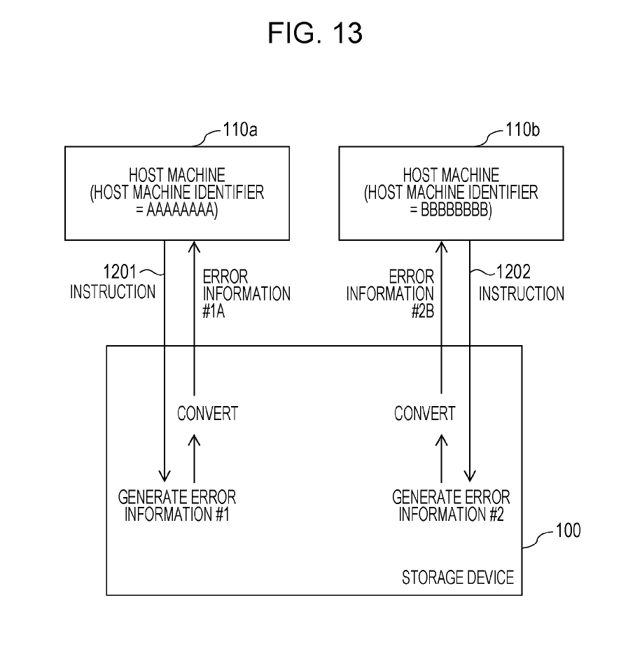

The sense data response process in step S1006 is to be described in detail. FIG. 12 illustrates in detail the sense data response process in step S1006.

Firstly, based on the fault detected by the error detecting unit 206 in step S1006, the error information generating unit 207 generates error information in response to the detected fault (S1101).

After generating the error information, the setting recognition unit 202 references a host machine identifier contained in the instruction that lead to the fault, and then determines whether the host machine response information corresponding to the referenced host machine identifier is stored in host machine response information 600 that is stored in the host machine response information storage unit 211 (S1102).

If the setting recognition unit 202 determines that the corresponding host machine response information is stored, the converting unit 208 converts the error information generated by the error information generating unit 207 in accordance with the set host machine response in step S1101 to the corresponding error information (S1103). Upon the conversion in step S1103, the converting unit 208 ends the response process (processing proceeds to step S1007 of FIG. 10).

However, if the setting recognition unit 202 determines in step S1102 that the corresponding host machine response information is not stored, the setting recognition unit 202 references the host machine information corresponding to the identifier from the host machine information 500 stored in the host machine information storage unit 210, and then determines whether the host machine attribute information corresponding to the host machine identifier is stored (S1104).

If the setting recognition unit 202 determines in step S1104 that the host machine attribute information is stored, the converting unit 208 converts the error information generated by the error information generating unit 207 in step S1101 to the corresponding error information in accordance with the stored host machine attribute information (S1105).

The conversion operation in step S1105 may be easily performed by, for example, causing an administrator of the system that includes the storage device 100 to register and store a conversion method in advance for each piece of the host machine attribute information (such as partition type information, or file system information). More specifically, the converting unit 208, without registering the conversion information individually on each host machine identifier, searches for the conversion method corresponding to the host machine attribute information identified in the method (of S807 in FIG. 8), and then acquires the conversion information to be applied to the host machine 110.

In addition, even if there is a host machine with an unknown conversion method, the converting unit 208 identifies the OS attribute information of the host machine with the unknown conversion method through, for example, the method of S807 of FIG. 8, and references the host machine information of FIG. 5. The converting unit 208 thus identifies a host machine identifier of another host machine corresponding to the same host machine attribute information as the identified host machine attribute information, and identifies conversion information corresponding to the host machine identifier of the other host machine identified by referencing the host machine response information of FIG. 6. The converting unit 208 may thus determine which conversion method to apply.

Subsequent to the operation in step S1105, the converting unit 208 ends the response process (proceeds to step S1007 of FIG. 11).

Turning back to the discussion of the process of FIG. 11, the transmitting unit 209 transmits the response to the host machine 110 in step S1007. If the process responsive to the instruction has been completed without any fault, then the transmitting unit 209 transmits to the host machine 110 a response to the instruction or a response to the effect that the processing in response to the instruction has completed. In addition, if the converting unit 208 has successfully completed the conversion of the error information in step S1103 or step S1105 in FIG. 12, the transmitting unit 209 transmits the converted error information to the host machine 110. If the converting unit 208 has failed to convert the error information, the transmitting unit 209 may transmit to the host machine 110 the error information generated by the error information generating unit 207 without being converted.

If the instruction processing unit 204 executes the exclusion process in step S1003 subsequent to the transmission of the response to the host machine 110 by the transmitting unit 209, the storage device 100 cancels the exclusion process (S1008), and ends the series of operations illustrated in FIG. 11.

Finally, the process of FIG. 11 will be specifically described. A host machine having an host machine identifier=AAAAAAAA (referred to as a host machine 110a) may transmit an instruction 1201 to the storage device 100, and the error information generating unit 207 in the storage device 100 may generate error information #1 during processing in response to the instruction 1201. Also, a host machine having a host machine identifier=BBBBBBBB (referred to as a host machine 110b) may transmit an instruction 1202 to the storage device 100, and the error information generating unit 207 in the storage device 100 may generate error information #2 during processing in response to the instruction 1202.

In the host machine response information 600 of FIG. 6, the host machine identifier=AAAAAAAA is associated with response #A701 as the conversion information. The response #A701 contains information to the effect that the error information #1 is to be converted into the error information #1A. Therefore, the converting unit 208 converts the error information #1 into the error information #1A in accordance with the information of the response #A701. The transmitting unit 209 transmits the error information #1A that has been converted by the converting unit 208 to the host machine 110a. As described above, the storage device 100 converts sense data #1, generated in the processing in response to the instruction 1201 from the host machine 110a, into the error information #1A, and then transmits the error information #1A to the host machine 110a.

The response to the host machine 110b is described next. Error information #2 is generated, but the host machine identifier=BBBBBBBB is not associated with any conversion information in the host machine response information 600 of FIG. 6 contained in the host machine response information.

In the host machine information 500 of FIG. 5 stored in the host machine information storage unit 210, the setting recognition unit 202 then searches for a host machine identifier associated with the host machine attribute information matching the host machine attribute information associated with the host machine identifier=BBBBBBBB. In this example, the host machine attribute information associated with the host machine identifier=AAAAAAAA and the host machine identifier=BBBBBBBB is “Windows (registered trademark) NTFS”, and a host machine identifier=CCCCCCCC is found in the search.

The host machine identifier=CCCCCCCC is associated with response #C703 in the host machine response information 600 of FIG. 6, and the response #C703 contains information to the effect that sense data #2 is to be converted into error information #2B.

In accordance with the conversion information associated with the host machine identifier=CCCCCCCC (the information of the response #C703), the converting unit 208 converts the generated error information #2 into the error information #2B. At this point, view of possible later conversion, the setting recognition unit 202 may update the host machine response information 600 so that the host machine identifier=BBBBBBBB is associated with the response #C703, and may update the valid bit of the host machine information 500 to “on”.

The transmitting unit 209 then transmits the error information #2B converted by the converting unit 208 to the host machine 110b. As described above, the storage device 100 may convert the error information #2, generated in the course of the processing in response to the instruction 1202 from the host machine 110b, into the error information #2B, and then transmit the error information #2B to the host machine 110b.

Through the above process, the storage device 100 may convert the error information and then transmit the converted error information to the host machine 110a identified by the host machine identifier=AAAAAAAA as illustrated in FIG. 13. Even if the host machine 110b identified by the host machine identifier=BBBBBBBB may not be associated with the conversion information, the storage device 100 converts the error information using the already stored OS type or the conversion information of another host machine in accordance with the host machine attribute information, and then transmits the converted error information to the host machine 110b.

The storage device 100 thus performs the processing in response to the instruction from the host machine 110 in the procedure described above. In accordance with the procedure of the embodiment, the error information generating unit 207 generates error information in response to a fault if the fault occurs while executing the processing, and the converting unit 208 performs error information conversion in accordance with the host machine, and then transmits the converted error information to the host machine 110. At this point, even if the host machine response associated with the host machine 110 is not configured, by acquiring the host machine attribute information of the host machine 110 the converting unit 208 may convert the error information, for example in accordance with the type of the OS of the host machine 110. Therefore, for a host machine that has no host machine response set, transmission of unconverted error information may be suppressed, and as a result, erroneous operation and a fault in the host machine 110 may be suppressed (reduced).

The system including the storage device 100 and the procedures of each process of the system as the embodiment have been described for exemplary purposes only, and may be modified without departing from the scope of the embodiment.

For example, in accordance with the embodiment, the information of the OS is acquired from the MBR. However, if a globally unique identifier (GUID) partition table (GPT) is used in place of the MBR, the host machine attribute information may be acquired by referencing information contained in the GPT.

In accordance with the embodiment, the storage device 100 including the controller 101 and the magnetic disk drive 105 has been described. However, the function of the embodiment may be, for example, implemented using a magnetic disk drive having the function of the controller 101.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable, non-transitory medium storing therein a control program that causes a storage device to execute a procedure, the procedure comprising:
acquiring, when a fault occurs in a process of the storage device, attribute information that indicates an attribute of an information processing apparatus that has instructed the process to the storage device; and
transmitting error information related the fault and the attribute information.

2. The computer-readable, non-transitory medium according to claim 1, the procedure further comprising:
specifying conversion information, corresponding to the attribute information of the information processing apparatus, by referencing an association relationship between the attribute information and the conversion information that are stored in the storage device; and
converting the error information corresponding to the fault in accordance with the identified conversion information.

3. The control program according to claim 1, wherein the attribute information indicating the attribute of the information processing apparatus is identified in accordance with a partition type stored in a storage area, accessed by the information processing apparatus, out of storage areas of the storage device.

4. The computer-readable, non-transitory medium according to claim 1, the procedure further comprising:
updating, when the attribute information indicating the attribute of the information processing apparatus fails to be acquired, a counter value corresponding to identification information that identifies the information processing apparatus; and
suppressing, when the counter value is above a specific value, a further trial process to acquire the attribute information of the information processing apparatus the attribute information that has been failed to be acquired.

5. A control method executed by a storage device, the method comprising:
acquiring, when a fault occurs in a process of the storage device, attribute information that indicates an attribute of an information processing apparatus that instructed the process to the storage device; and
transmitting error information related the fault and the attribute information.

6. A storage device comprising:
a storage unit that stores identification information of a first information processing apparatus, conversion information indicating a conversion method of error information corresponding to the first information processing apparatus, and computer-readable an instruction; and
a processor configured to execute the stored instruction including:
generating, when a fault occurs in a process ordered by a second information processing apparatus, error information corresponding to the fault;
specifying attribute information that indicates an attribute of the first information processing apparatus either by analyzing data stored in an area of the storage unit that stores data indicating a format of an area as an access destination of the first information processing apparatus or by analyzing data to be written onto an area that stores data indicating the format, and identifying attribute information indicating an attribute of the second information processing apparatus either by analyzing data stored in an area of the storage unit that stores a format of an area as an access destination of the second information processing apparatus or by analyzing data to be written onto an area that stores data indicating the format;
converting, when a content of the attribute information of the second information processing apparatus includes a same content of the attribute information of the second information processing apparatus, the error information that corresponds to the fault in accordance with conversion information that indicates a conversion method for the error information corresponding to the first information processing apparatus stored in the storage unit; and
transmitting the converted error information to the second information processing apparatus.
